(19) United States
(12) Patent Application Publication
(10) Pub. No.: US 2024/0428984 A1
(43) Pub. Date: Dec. 26, 2024

(54) SURFACE MOUNTING INDUCTIVE COILED COMPONENT FOR MOUNTING ON PRINTED CIRCUIT BOARDS

(71) Applicant: PREMO, SL, Campanillas (MALAGA) (ES)

(72) Inventors: Francisco Ezequiel NAVARRO PÉREZ, Barcelona (ES); Antonio ROJAS CUEVAS, Málaga (ES); Claudio CAÑETE CABEZA, Benalmádena (ES); Paula PÉREZ CAMERO, Vélez-Málaga (ES); Sergio COBOS REYES, Málaga (ES)

(21) Appl. No.: 18/294,837

(22) PCT Filed: Jul. 29, 2022
(86) PCT No.: PCT/EP2022/071359

§ 371 Date: Feb. 5, 2024

(30) Foreign Application Priority Data
Aug. 3, 2021 (EP) 21382732.2

(51) Int. Cl. H01F 27/29; H01F 27/24

(52) U.S. Cl. CPC H01F 27/292; H01F 27/24

(57) ABSTRACT

A surface mounting inductive coiled component for printed circuit boards, the component has at least one winding groove for the arrangement of at least one conductive coil to be wounded around a monolithic core (1), and several connecting interfaces (2) attached to the monolithic core (1) for connecting the at least one conductive coil to the tracks of a circuit board, wherein the monolithic core is made of an injection mouldable polymer body including magnetic charges in a proportion comprised between 70% up to 85% by weight, selected to provide magnetic inductance and assure electrical isolation between the connecting interfaces that are integrated in the monolithic core which is thermally conductive and wherein the magnetic charges include powdered magnetic charges or the magnetic charges include powdered magnetic charges and further include at least one solid sintered core (3) of magnetic material embedded in the polymer body.

### FIELD OF THE INVENTION

The present invention generally relates to the field of inductive coiled components specifically designed for mounting on printed circuit boards (PCBs). In most cases, these components incorporate a mechanical interface intended for connection to the PCB, and this is usually done for small currents such as those used in electronics by means of PTH (Pin Through Hole) or SMT (Surface Mount Technology) pins/pads.

Generally, these inductive components consist of three main elements: a magnetic core, a base or bobbin holding the magnetic core, and a coil or winding wound around the magnetic core.

The materials of the cited three main elements have quite different electrical and magnetic conductivity characteristics. The base or bobbin usually comprises a polymeric material based on technical plastics such as phenolics, polyamides, etc. and is highly insulating, allowing the pins/pads (SMD or PTH) to be housed on it (pinned or injected) to bind and solder the winding wires. The base or bobbin therefore has a structural function (it supports and houses the magnetic core and winding) and also a functional function (it provides the necessary electrical insulation). On the other hand, the magnetic core is usually made of metal-based materials, their amorphous or crystalline alloys or sintered or compacted powders of metal oxides or alloys. These materials usually have a certain electrical conductivity, which increases Eddy current, induced losses and requires electrical isolation of the magnetic core relative to the winding and the PCB by means of the plastic base or bobbin.

One of the possible applications of these inductive coil components is for low-frequency coiled antennas for RFID, for instance, to be used in keyless entering systems where the risk of a falling key or shock should be a variable that must be considered. That is, the inductive components mounted on a key must be able to withstand drops without damage.

The aim of this invention is to obtain inductive components that successfully support standard drop tests in the industry and do not require a base or bobbin holding the magnetic core for mounting on SMT or PTH, simplifying the manufacturing costs of the inductive component and without impairing the properties (inductance, Q factor, DC resistance and sensitivity) of the inductive component.

### STATE OF THE ART

A standard structure of inductive coiled components comprises a non-electrically conductive base or bobbin (e.g., made of plastic) which houses a magnetic core, on which a coil/winding is wound. By way of example only, the following patent documents can be indicated: US20150155629, CN201789061U, ES2459892 and EP2911244.

In addition, the US2013033408A1 discloses a core assembly for a three axis antenna comprising a first core member having a body around which an X-axis coil and a Y-axis coil are wound, a second core member comprising a body around which an X-axis coil and a Y-axis coil are wound and a bobbin comprising an annular portion functioning as a space for disposing said first core member from one side, and receiving at least part of the body of said second core member from the other side, such that the body of said first core member and the body of said second core member are at least partially adjacent to each other.

European patent EP1620920B1 discloses an inductive miniature component comprising a winding element of ferrite material embodied as an essentially flat, multi-sided part, wherein three windings are disposed on said winding element such that axes of said windings extend in three spatial directions that are respectively perpendicular to one another, firsts and second guiding elements and a coil plate of electrically non conducting (polymeric material), non-ferromagnetic material wherein said winding element and said coil plate are placed together and interconnected and gluing ensures a fixed connection.

To prevent the core from detaching from the base/bobbin upon accidental impact, pulling the wires apart and breaking them, either two-component structural adhesives have been used in the field, often epoxy-based alone or in combination with epoxy transfer injection moulding. However, these processes of manufacture of the referred inductive coiled components are expensive and time-consuming because of the type of machinery used (i.e., assembly machines with curing ovens and epoxy injection moulding machines with complex precision moulds).

In addition, in many cases a sheet of absorbent foam is provided to cushion impacts on the component during drop test, preventing the breakage or detachment of the components constitutive thereof.

International patent application WO2014072075A1, of the same applicant of present invention, discloses a monolithic magnetic core configured for connection to a PCB by means of PTH or SMT pins/pads, and involves metallisation of the core. A monolithic magnetic core with configurations providing the paths for winding the coils is very costly, has the risk of core breakage, and of brittleness of the ferrites. Moreover, the electrical conductivity of the core limits the solution to very small, metallised ferrites and Fe and Ni oxides (low permeabilities, but high electrical resistivity).

In other words, these solutions also require cushioning elements to resist impacts, thus increasing the cost of the solution.

European patent EP2928039B1 discloses a soft magnetic substrate of a wireless power transmitting apparatus, comprising one side configured to accommodate a transmitting coil, wherein a groove corresponding to a shape of the transmitting coil is formed in the one side configured to accommodate a first transmitting coil and a second transmitting coil disposed parallel to the first transmitting coil, and a third transmitting coil disposed on the first transmitting coil and the second transmitting coil wherein the groove includes a wall configured to surround at least a part of an outer circumference of the first transmitting coil, at least a part of an outer circumference of the second transmitting coil, and at least a part of an outer circumference of the third transmitting coil. The referred soft magnetic substrate is integrally formed through an injection moulding of a composite having 83 to 87 wt % of at least one of Fe—Si—Al alloy powder/flakes and Fe—Si—Cr alloy powder/flakes, and 13 to 17 wt % of at least one among a polyvinyl (PV) based resin, a polyethylene (PE) based resin, and a polypropylene (PP) based resin. Unlike present invention, this patent does not disclose or suggest an inductive component specifically designed for surface mounting (see int his regard FIG. 6 of drawings and related description), taking advantage of the electro-insulating characteristics of the substrate.

Therefore, there is a need to provide a cheaper and unbreakable inductive coiled component, which can withstand drop testing without foams, absorbers, addition of chip bonders, especially in the case of components that are mounted on keys or on mobile or portable devices, eliminating the risk of a drop producing an impact fracturing the core.

### Disclosure of the Invention

In view of the above, an objective of the invention is to overcome the drop test with a more flexible and unbreakable inductive coiled component, as well as simplify the process and reduce the number of elements of the inductive component from three to two, although hybrid solutions are possible and innovative.

To that end, this invention consists of fusing the core element and the base element or bobbin into one monolithic core by injection moulding providing an element that houses the connecting interfaces, is ferromagnetic, structurally stable, provides electrical insulation, and that is sufficiently flexible and plastic to absorb impact energy without fracturing.

The present invention covers the content of the claims included below.

The proposed inductive coil component for mounting on printed circuit boards comprises, as known in the art, at least one winding groove for the arrangement of at least one conductive coil to be wounded around a monolithic core, and several connecting interfaces attached to the monolithic core for connecting the at least one conductive coil to the tracks of a circuit board.

Characteristically, the monolithic core is made of an injection mouldable polymer body including magnetic charges, comprised between 70% and up to a maximal proportion by weight of 85% selected to provide magnetic inductance and to assure electrical isolation between the connecting interfaces that are integrated in the monolithic core which is thermally conductive and wherein the magnetic charges include powdered magnetic charges.

In some embodiments, this invention proposes an inductive coiled component comprising a monolithic core with integrated connecting interfaces (embedded therein), the monolithic core providing magnetic inductance and being made of an injection mouldable polymer body including magnetic charges, comprised between 70% and up to a maximal proportion by weight of 85%, wherein upper limit is selected to assure electrical isolation between the mentioned connecting interfaces of the monolithic core which is thermally conductive. Magnetic charges include in whole or in part powdered (micro or nano particles) magnetic charges.

In an embodiment, the polymeric body is made of a PBM material (Polymer of PBT, PA 66, LCP, Peek, Polyimide, plus dispersant and flame retardant additives with a loading of at least 70% by weight of ferromagnetic micro and nano particles typically ferrite or iron powder or powdered ferromagnetic alloys), particularly based on nano and micro particles of appropriate sizes and of appropriate initial permeabilities; thus a new core that now has the entire volume previously occupied by the core plus the spool or base is obtained.

While the effective permeability of a PBM core is lower than that of a compact core of the same material incorporated in an electro-insulating base according to the above mentioned standard structure for an inductive coiled component, the invention solves the problem of the cited state of the art by increasing the total magnetic core volume which incorporates in the mouldable polymer body including magnetic charges (for example PBM case) the standard core volume plus that of the base or bobbin. In this way, it is possible to achieve sufficient permeability and final sensitivity for the inductive component.

That is, considering the entire volume occupied by the base or bobbin as additional core volume changes the paradigm from plastic to a single multifunctional composite material, by adding additional functionalities to the former (permeability, thermal conductivity, and shock absorbency).

Until now, the known techniques considered that PBMs were not technically competitive as cores against compact materials since the loss of density, fragmentation and grain sizes in the matrix limit and reduce significantly the main variable sought, i.e., magnetic permeability.

It was also not evident that 80% or more weight of magnetic charges could be obtained in the PBM or that they would not incur in percolation phenomena.

The invention takes advantage of advances in polymers, extrusion, and nanotechnology techniques such as planetary zirconium ball milling, as well as the availability of mixes, having allowed materials with viable rheology to be injected at high pressure and temperature in conventional plastic injection moulding machines, allowing vertical integration of the core and base or bobbin manufacturing processes, improving costs.

Besides, PBM integral components unlike the solutions explained above based on monolithic magnetic cores, in addition to solving the above-mentioned shortcomings, when made (core and base) by injection moulding, can have shapes that are not obtainable from the conventional process in ferrites or sintered cores that are obtained by pressing and sintering in furnaces at over 1000 C.

In an embodiment, all the magnetic charges included in the polymer body constituting the magnetic core are powdered magnetic charges.

Alternatively, the magnetic charges include powdered magnetic charges and at least one solid sintered core of magnetic material embedded in the polymer body. It will be understood that the solid sintered core is a non-powdered core.

In any case, the magnetic charges can be micro and/or nano ferromagnetic particles. In this case, the micro and/or nano ferromagnetic particles can be ferrite particles and/or iron powder and/or ferromagnetic alloys.

In an embodiment, the maximal proportion of magnetic charges in the polymer body is about 75% by weight.

The polymeric body can be made of a PBM material including dispersant additives and/or flame retardant materials.

According to a particular embodiment, the monolithic inductive component of this invention comprises at least three winding grooves, each arranged surrounding one of three orthogonal axis X, Y and Z, for locating three orthogonal conductive coils around the monolithic inductive component.

In an embodiment, the monolithic inductive component shape is selected to be producible in a two-part mould, i.e., the shape of the monolithic core allows the fabrication of the monolithic core in a mould made of only two parts, allowing the extraction of the produced core from the two-part mould once opened. To achieve this result, the shape of the monolithic core is particularly devoid of grooves or depressions in the perimetral surfaces of the monolithic core.

In another embodiment, it is possible to enhance the permeability of the inductive component additionally with a hybrid solution, in which a simple and inexpensive core of very simple shapes such as a cube, a sphere, a tetrahedron, a disk or a cylinder is included in the mould, so that it results over-moulded or over-injected with a PBM that provides the functions mentioned above. With this hybrid solution it is possible to overcome a drop test resistance with an increased sensitivity and permeability and lower cost.

In addition, the invention allows its incorporation in the circular economy by being able to make PBM pellets for injection from waste ferrites and other recovered cores.

Therefore, the present invention avoids the sintering of ferrites, by using waste and move from a dirty and intensive process in energy and CO2 generation to a clean injection process.

### BRIEF DESCRIPTION OF THE DRAWINGS

The above and other features and advantages will be more fully understood from the following detailed description of merely illustrative and non-limiting embodiments with reference to the accompanying drawings, in which:

FIG. 1 is a perspective of an embodiment of an inductive component according to this invention comprising a monolithic magnetic core made of an injection mouldable polymer body including magnetic charges with integrated connecting interfaces embedded therein. In this example the connecting interfaces are connecting pins.

FIG. 2 illustrates in a perspective view a second embodiment with a ferrite disc integrated in the referred monolithic magnetic core made of an injection mouldable polymer body.

FIG. 3 shows in a perspective view another embodiment in which a cubic ferrite body is integrated within the referred monolithic magnetic core made of an injection mouldable polymer body. The figure shows the external appearance of the inductive component and also the internal arrangement of the cubic ferrite body.

### DETAILED DESCRIPTION OF SEVERAL EMBODIMENTS

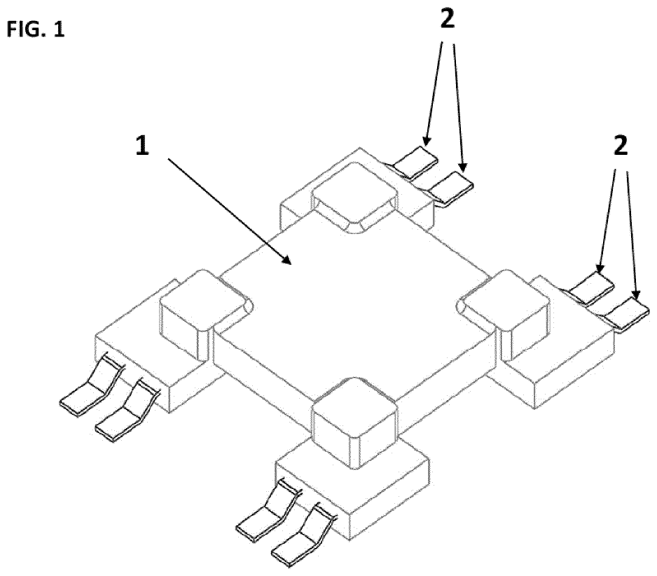

FIG. 1 shows an inductive component comprising a monolithic thermally conductive magnetic body made of an injection mouldable polymer body including magnetic charges, comprised between 70% and up to a maximal proportion by weight of 85% selected to provide magnetic inductance and assure electrical isolation between connecting interfaces 2 that are integrated embedded in the monolithic core which is and wherein the magnetic charges include powdered magnetic charges.

The shape of the magnetic core brings the standard shape of a plastic bobbin, i.e., it provides orthogonal channels to arrange around the windings of the coiled inductive component arranged in a typical manner.

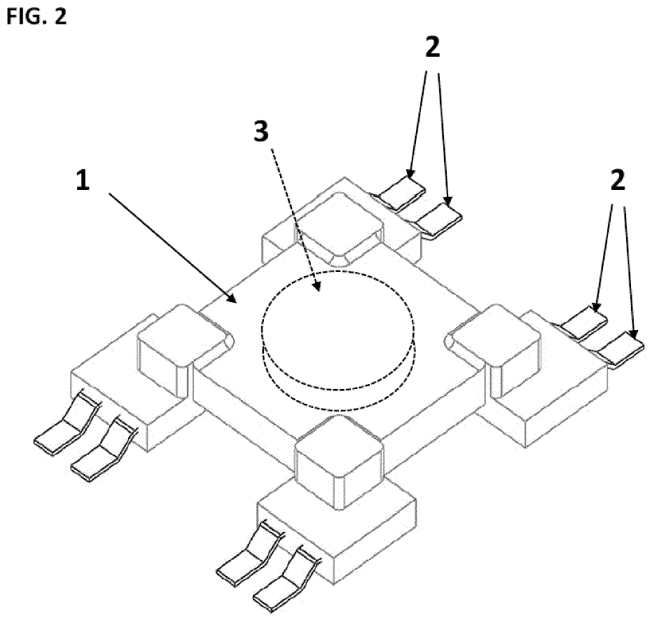

The embodiment of FIG. 2 is entirely equivalent to the one shown in FIG. 1, although one solid sintered core 3 of a magnetic material, as part of the magnetic charges, is embedded in the polymer body. In this example, the solid sintered core 3 is a thin ferrite disk of a very low cost inserted in the mould, so that the ferrite disk is completely integrated into the injected polymer body with magnetic charges.

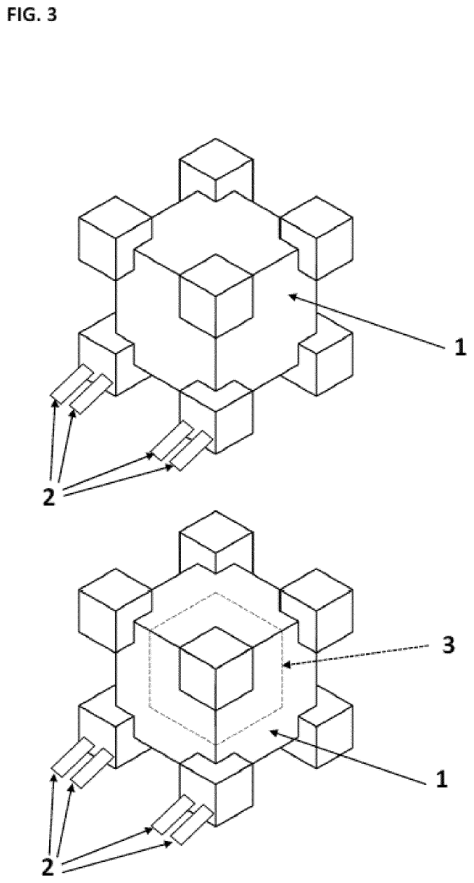

Finally, FIG. 3 shows another embodiment in which the solid sintered core 3 is a cubic block of ferrite been inserted into the injected polymeric body with magnetic charges constituting a hybrid magnetic core. In this embodiment the magnetic core includes eight spatially distributed corner protuberances defining therebetween the referred three orthogonal grooves.

The thickness of the sintered core 3 is comprised between 0.5 and 1.5 mm.

The scope of the present invention is defined in the claims that follow.

1. A surface mounting inductive coiled component for printed circuit boards, the inductive coiled component comprising a monolithic core that comprises:
three orthogonal winding guiding configurations, each arranged surrounding one of three orthogonal axis X, Y and Z, for locating three orthogonal conductive coils around the monolithic core; and
several connecting interfaces attached to the monolithic core for connecting each conductive coil of said three orthogonal conductive coils to tracks of a printed circuit board,
the monolithic core is made of an injection mouldable polymer body comprising magnetic charges comprising powdered magnetic charges, in a proportion comprised between 70% up to 85% by weight, selected to provide magnetic inductance, assure electrical isolation between the connecting interfaces, and a thermal conductivity higher than 4 W/mK; and
the connecting interfaces are embedded in the monolithic core.

2. The surface mounting inductive coiled component according to claim 1, wherein all the magnetic charges comprised in the polymer body are powdered magnetic charges.

3. The surface mounting inductive coiled component according to claim 1, wherein the magnetic charges comprise powdered magnetic charges and at least one solid sintered core of magnetic material embedded in the polymer body providing a hybrid magnetic core.

4. The surface mounting inductive coiled component according to claim 3, wherein the solid sintered core is devoid of protuberances and selected between a flat or polyhedric element.

5. The surface mounting inductive coiled component according to claim 3, wherein the sintered core represents less than 15% in weight or volume of the whole monolithic core.

6. The surface mounting coiled component, according to claim 4, wherein the solid sintered core has a thickness comprised between 0.5 and 1.5 mm.

7. The surface mounting inductive coiled component according to claim 1, wherein a maximum proportion of magnetic charges in the polymer body is 75% by weight.

8. The surface mounting inductive coiled component according to claim 1, wherein the polymeric body is made of a PBM material, comprising dispersant additives or dispersant additives and a flame retardant material.

9. The surface mounting inductive coiled component according to claim 1, wherein the magnetic charges are micro and/or nano ferromagnetic particles.

10. The surface mounting inductive coiled component according to claim 9, wherein the micro and/or nano ferromagnetic particles are ferrite particles and/or iron powder and/or ferromagnetic alloys.

11. The surface mounting inductive coiled component according to claim 1, wherein the monolithic core has a shape that is selected to be producible in a two-part mould.

12. The surface mounting inductive coiled component according to claim 1, wherein the connecting interfaces are metallic conductive elements at least partially embedded in the polymeric body.

13. The surface mounting inductive coiled component according to claim 12, wherein the connecting interfaces are mounting pins or pads.

14. The surface mounting inductive coiled component according to claim 1, wherein two of said three orthogonal winding guiding configurations are two orthogonal grooves each surrounding the monolithic core.
